(19) United States
(12) Patent Application Publication
(10) Pub. No.: US 2016/0026218 A1
(43) Pub. Date: Jan. 28, 2016

(54) FOLDABLE TABLET COVERS

(71) Applicant: LENOVO (SINGAPORE) PTE. LTD., Singapore (SG)

(72) Inventors: Nicole L. Jefferies, Cary, NC (US); Hiroki Hirano, Fujisawa-Shi (JP); Yoshihito Nakagaki, Yokohama-Shi (JP)

(73) Assignee: LENOVO (SINGAPORE) PTE. LTD., Singapore (SG)

(21) Appl. No.: 14/341,298

(22) Filed: Jul. 25, 2014

(51) Int. Cl. G06F 1/16; F16M 11/22; A45C 13/10; A45C 11/00; A45C 13/00

(52) U.S. Cl. CPC G06F 1/1628; A45C 11/00; A45C 13/005; A45C 13/1069; F16M 11/22; A45C 2011/003; F16M 2200/08

(57) ABSTRACT

A foldable tablet cover is described. The tablet cover can be used in multiple configurations, or stand modes, in which rubber attached to the tablet cover will provide friction so as to prevent slipping of the tablet while in use.

### FIELD OF THE INVENTION

The present invention relates generally to electronic device covers, and more particularly to foldable tablet PC covers.

### BACKGROUND OF THE INVENTION

With the advancing of technology the various types of electronic devices continues to develop. Particularly, more and more electronic devices include touch screens for the ease of the user. Touch screen tablets have become increasingly popular with the improvements in technology. Most users of touch screen devices utilize a cover to protect the display from damage, and a stand to allow easier use of the device and prevent the user from having to use the device laying flat on a surface such as a desk.

Tablet covers are used to protect the screen of a tablet PC, in particular a touch-screen tablet. Tablet covers can also serve as a pedestal for the tablet, functioning as a stand. Some tablet PC covers have a functionality including “stand mode” for watching movies or using touch operations without the user having to hold it in their hands by folding the covers and other methods. However, existing tablet covers can slip when they are in pedestal configurations, and the cover will not always be at the correct angle for the user. Traditional tablet covers do not maintain static friction with the supporting table or structure when they are in use as a pedestal, so putting force on the screen, i.e. using the tablet, can cause slipping on the surface the tablet is resting on.

U.S. Pat. No. 8,264,310 teaches a “smart cover” for a tablet PC that can be folded and makes a triangular structure which functions as a tablet stand. However, this tablet cover does not have a functionality to prevent slipping during touch operations in stand mode.

Accordingly, there remains a need for improved foldable tablet covers that can prevent slipping when used in stand mode.

This invention solves the issue of slipping by employing enough friction force using rubber feet on a cover for a tablet. The rubber feet can maintain the position of the tablet while the user touches the tablet during operation. The two rubber feet can also provide multiple “stand modes” by allowing the cover to fold in multiple ways. The user can choose the stand mode that best suits the use of the tablet. This invention generally provides a foldable tablet cover including rubber feet that prevent the tablet from slipping when the screen is touched.

### SUMMARY OF THE INVENTION

A device is provided that in one embodiment includes

### BRIEF DESCRIPTION OF THE DRAWINGS

The invention will be more fully understood from the following detailed description taken in conjunction with the accompanying drawings, in which:

FIG. 1 shows a tablet with the tablet cover attached and in an open configuration.

FIGS. 2A-2D show the tablet cover in use in stand mode 1.

FIGS. 3A-3E show the tablet cover in use in stand mode 2.

### DETAILED DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

In the present disclosure, like-named components of the embodiments generally have similar features, and thus within a particular embodiment, each feature of each like-named component is not necessarily fully elaborated upon. Sizes and shapes of devices and components of electronic devices discussed herein can depend at least on the electronic devices in which the devices and components will be used and the invention described herein is not limited to any specific size or dimensions.

A person skilled in the art will appreciate that the devices and methods disclosed herein can be implemented using any type of electronic device. The cover of this invention can be used for any type of electronic device, including but not limited to a tablet PC (“tablet”), a mobile telephone, a smartphone, a computer (e.g., a laptop or notebook computer, a netbook, a server, a tablet, etc.), a DVD player, a CD player, a portable music player, a gaming system, a television, a radio, a personal digital assistant (PDA), etc. In a preferred embodiment the device is a touch screen electronic device. In a more preferred embodiment, the device is a touch screen tablet.

Various exemplary foldable tablet covers are provided. In general, this invention provides a foldable cover for a tablet that can be removably attached to a tablet. When the cover is attached to a tablet or other electronic device, the cover can be “closed,” completely protecting the display, or “open,” completely exposing the display. The cover of this invention can also be used as a stand for the tablet in multiple “stand modes.”

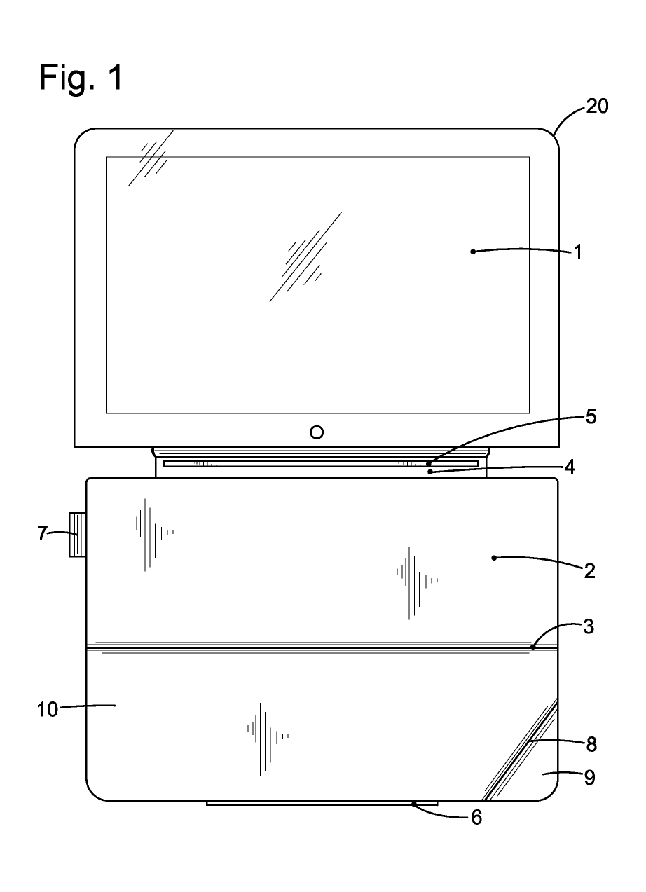

FIG. 1 shows a display 1 of a tablet 20 with a cover 2 removably attached thereto in an open position, with the inside of the cover 10 and the display 1 exposed. A flexible hinge 4 connects the cover 2 to the display 1 and allows the cover 2 to open and close with respect to the display 1. The cover 2 can include a folding line 3 in the center of the cover, parallel to the hinge 4. The cover 2 can include two feet, foot 5 and foot 6. Foot 5 can be disposed on the hinge 4, Foot 6 can be disposed on the end of the cover opposite the hinge. Alternatively, foot 5 can be disposed on the cover near the hinge. The cover 2 can optionally include a foldable corner 9, defined by an additional folding line 8. The cover 2 can also optionally include a pen holder 7 on a side of the cover perpendicular to the hinge 4.

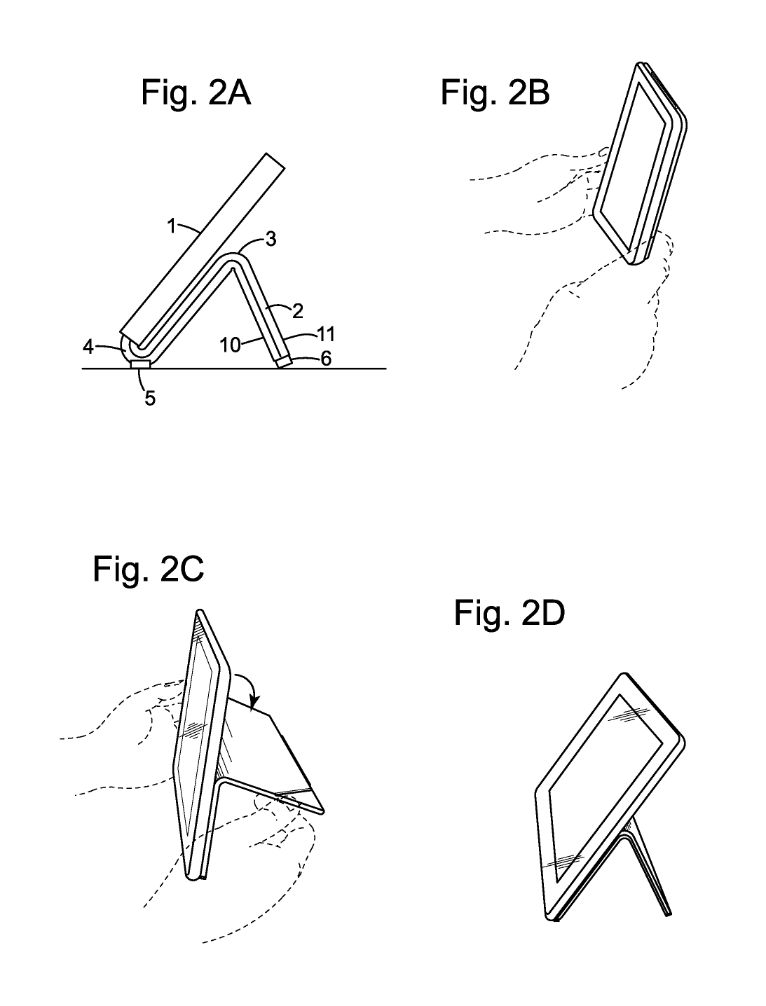

The cover 2 can be made of any material suitable for use in protective covers for electronic devices, for example plastics, polymers, hybrid materials, hard materials, soft materials, cloths, etc. The entire cover 2 can be made of the same material. In a preferred embodiment, the inside of the cover 10 is made of a different material than the outside of the cover 11. In a preferred embodiment, the inside of the cover 10 can be constructed of a hybrid material like a soft cloth to prevent scratching and damage to the display 1. In another preferred embodiment, the outside of the cover 11 (see FIG. 2A) can be made of a hard material like a plastic or polymer.

The cover 2 can be connected to an electronic device by a flexible hinge 4. Preferably the cover 2 is removably connected to the electronic device via the hinge 4 on the cover 2. In a preferred embodiment the cover 2 can attach to a tablet with a magnet on the hinge (not shown). The hinge 4 on the cover is flexible to allow for the cover to both open and close on the tablet. When the cover 2 is open, the display 1 of the tablet is completely exposed (shown in FIG. 1). When the cover 2 is closed, the display 1 of the tablet is completely covered (not shown). The hinge 4 of the inventive tablet cover can be made of any material suitable for similar hinges. For example, the hinge can be made of metals, plastics, polymers, elastomers, etc. In a preferred embodiment, the hinge of the inventive tablet cover can be made of a soft material to facilitate bending. Further, the flexible hinge can include a foot 5 on one surface which faces inside when the cover is closed.

The cover 2 of this invention can have a folding line 3 that runs parallel to the hinge 4. The folding line is preferably centered on the cover, as shown in FIG. 1. The folding line 3 is flexible to allow the cover 2 to function in multiple different stand modes. However, the folding line 3 is durable enough to allow folding of the cover multiple times without compromising the integrity of the cover. The folding line can be formed by partly reducing the stiffness of the cover 2 along the line. For example, reducing the thickness of the hard material along the line, or a solid interlining of a laminate structure is omitted along the line. The flexible hinge 4 combined with the flexible folding line 3 allow the cover 2 to function in multiple stand modes.

The cover 2 of this invention provides friction between the cover and a surface that the tablet is resting on when in stand modes. This friction allows the tablet to be used in stand modes without slipping, which is particularly useful for tablets with touch screen displays. To prevent slipping, the tablet cover can have one or more “feet.” In a preferred embodiment, the cover 2 has two feet, one on the hinge 4, Foot 5, and one at the edge of the tablet cover, Foot 6. The feet 5, 6 of the cover 2 can be manipulated into different positions based on how the cover is folded by using the folding line 3 and hinge 4.

The feet 5, 6 can be made of a variety of materials and attached to the cover using any conventional attachment method. The feet 5, 6 can be attached to the outside 11 or the inside 10 of the cover 2. In a preferred embodiment the feet 5, 6 can be attached to the inside 10 of the cover 2. In a preferred embodiment, foot 5 can be inside of the cover 2 when it is closed. In a more preferred embodiment foot 5 can be attached to an internal frame on the hinge 4. The feet can be bonded or glued to the cover. The feet 5, 6 can also be attached using double injection with the internal structure of the cover. The material used for the feet 5, 6 should have more friction than the cover materials to prevent slipping in stand mode. Accordingly, the feet 5, 6 can be made of any high-friction material. In a preferred embodiment, the feet are made of a rubber material. The feet 5, 6 can extend in a line parallel to the bottom of the display. In another preferred embodiment, the thickness and height of the feet should be in the range of about 1 mm to about 3-4 mm. In yet another preferred embodiment the length of the feet should be about 150 mm. In another embodiment, multiple feet can be attached to the cover and/or hinge. These multiple feet can have various shapes including spherical, hemi-spherical, rectangular, rounded, etc.

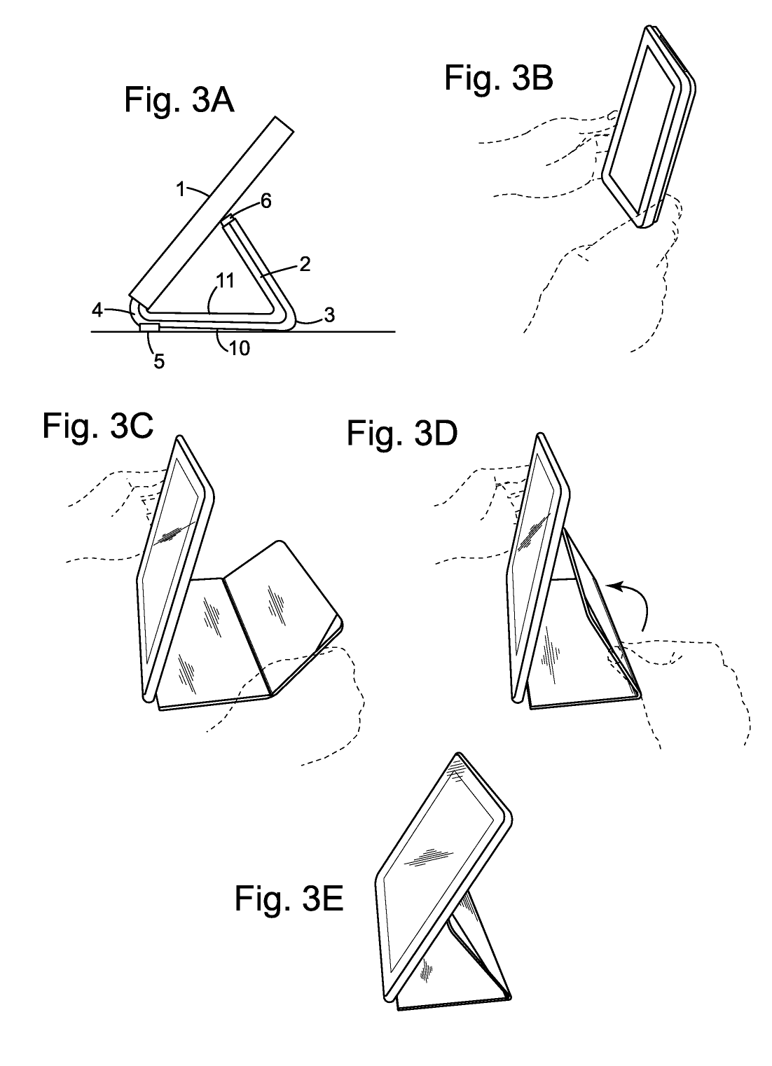

The cover of this invention can be used in multiple stand modes. Stand modes 1 and 2 shown in FIGS. 2A-2D and 3A-3E, respectively, represent preferred stand modes, but in no way are limiting on the uses of the cover of this invention. In stand mode 1, shown in FIG. 2A, feet 5, 6 contact the surface, thereby creating high friction with a surface upon which the tablet is resting. Therefore stand mode 1 is more useful when the surface is slippery. FIGS. 2A-2D show the cover in use in stand mode 1. FIG. 2A shows both foot 5 and foot 6 applied to the surface upon which the tablet is standing thereby creating friction between the tablet and the surface. In stand mode 1, the display 1 is completely exposed so that the display 1 can be used and viewed in this stand mode. The display 1 is resting on the cover 2, and the folding line 3 is bent so that the outside 10 of the cover 11 faces the tablet while the inside of the cover 10 faces the surface on which it is standing (not shown). The hinge 4 is completely open to expose foot 5 to the surface. To manipulate the cover into stand mode 1 the cover 1 is moved by a user from an open position in FIG. 2B and folded into a triangular stand mode shown in FIGS. 2C-2D.

In stand mode 2, shown in FIG. 3, only foot 5 contacts the surface. Therefore, stand mode 2 provides less friction with the surface than stand mode 1, but because foot 6 contacts the tablet stand mode 2 provides more support to both the screen of the tablet 20. FIGS. 3A-3D show the cover in stand mode 2. FIG. 3A shows that in stand mode 2 friction force from foot 6 is applied to the back of the display 1, and friction force from foot 5 is applied to the surface the stand is resting on. The inside of the cover 10 is facing the surface while the outside of the cover 11 is facing the tablet. In stand mode 2, the portion of cover 2 between the hinge 4 and the folding line 3 is resting on the surface. The folding line 3 is bent to form a triangle with the tablet. The display 1 is completely exposed so that the display may be used and viewed in this stand mode. To manipulate the cover into stand mode 2, a user can take the cover 2 from an open position shown in FIG. 3B, and fold it into a triangle with the tablet as shown in FIGS. 3C-3E.

As shown in FIGS. 2A and 3A, Foot 5 is integral to the functioning of the cover in stand modes 1 and 2. If foot 5 is not included on the cover 2, stand mode 2 would have less friction with the surface upon which the tablet is resting and further, in stand mode 1 the cover 2 would not be able to fold steadily because there would be less friction at the hinge of the cover.

### Optional Features

Optionally the cover can include magnet (not shown) between the inside of the cover 10 and the outside of the cover 11, to securely close it against the tablet. Further optionally the tablet can include a sensor at the edge of the tablet (not shown) to sense the closure of the cover 2 including the magnet (not shown). In a preferred embodiment the magnet is included in the cover 2 on the side of the folding line 3 furthest from the hinge 4. In an embodiment including the magnet, in standing mode 1 the magnet will not be in contact with the tablet. In standing mode 2, foot 6 will be between the magnet and the tablet. Therefore, the cover of this invention provides less chance of magnetic interference with the tablet in both stand modes 1 and 2.

Further optionally, the cover 2 can include a pen holder 7 on the side of the cover 2 perpendicular to the hinge, shown in FIG. 1. The pen holder can be configured to receive a pen, stylus, or other writing device. In a preferred embodiment the pen holder can be configured to receive a stylus for use with the device. In standing mode 1, shown in FIG. 2A, the pen holder (not shown) will be next to the display 1 of the tablet and the pen holder will still be functional in this standing mode.

Further optionally, the cover can include a foldable corner 9 on the cover 2, defined by an additional folding line 8. This foldable corner can assist the user in manipulating the cover. Specifically, when the cover 2 includes a magnet for closing the cover 2 against the display 1, the foldable corner 9 will not include a magnet. Accordingly, the foldable corner will allow the user to move the cover 2 from a closed position to an open position easily.

Although the invention has been described by reference to specific embodiments, a person skilled in the art will understand that numerous changes may be made within the spirit and scope of the inventive concepts described. A person skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A cover for an electronic device comprising:
a hinge that attaches the cover to the device, the cover being able to pivot about the hinge relative to the display from a fully open position exposing the display to a fully closed position covering the display,
the cover comprising an inner and outer layer wherein the inner layer touches the screen when fully closed and the outer layer is exposed when fully closed,
the cover further comprising at least a first segment and a second segment separated from the first segment by a folding line extendable parallel to the hinge, each segment including at least one foot comprised of high-friction material,
wherein in a first folded configuration both feet make contact with a surface on which the device rests and in a second folded configuration one of the first and second feet contacts a surface and the other one of the first and second feet contacts the device,
wherein the first foot and second foot are attached to the cover, one of the first and second foot is attached on the hinge, and the other one of the first and second feet is attached on the end of the cover opposite the hinge.

2. The cover of claim 1, further comprising a pen holder attached to the first segment configured to hold a pen, stylus, or other writing instrument.

3. The cover of claim 1, wherein the high-friction material has a coefficient of friction greater than a coefficient of friction of the cover.

4. The cover of claim 1, wherein the high-friction material is rubber.

5. (canceled)

6. The cover of claim 5 wherein both feet are disposed on the inner layer of the cover.

7. The cover of claim 1, wherein one corner of the second segment of the cover is foldable.

8. The cover of claim 1, wherein the hinge includes a magnet for removable attachment to the tablet.

9. The cover of claim 1, wherein the inner and outer layers of the cover are made of different materials.

10. The cover of claim 8, wherein the inside of the cover is made of a soft cloth and the outside of the cover is made of a hard plastic.

11. The cover of claim 1, further comprising a magnet disposed in between the inner and outer layers of the cover.

12. (canceled)

13. The cover of claim 1, wherein the electronic device includes a touch screen display.

14. The cover of claim 1, wherein the hinge removably attaches the cover to the device.

15. A cover for an electronic device comprising: a hinge that attaches the cover to the device, the cover being able to pivot about the hinge relative to the display from a fully open position exposing the display to a fully closed position covering the display, the cover comprising an inner and outer layer wherein the inner layer touches the screen when fully closed and the outer layer is exposed when fully closed, the cover further comprising at least a first segment and a second segment separated from the first segment by a folding line extendable parallel to the hinge, one of said first and second segments includes at least one foot comprised of high-friction material, and the hinge includes at least one foot comprised of high-friction material, wherein in a first folded configuration both feet make contact with a surface on which the device rests and in a second folded configuration the foot of the hinge contacts a surface and the foot of the first or second segment contacts the device,
wherein the first foot and second foot are attached to the cover, one of the first and second foot is attached on the hinge, and the other one of the first and second feet is attached on the end of the cover opposite the hinge.

16. The cover of claim 1, wherein the first and second segments include a plurality of feet.

17. The cover of claim 15, wherein the one of the first and second segments includes a plurality of feet, and the hinge includes a plurality of feet.
